(19) United States
(12) Patent Application Publication
(10) Pub. No.: US 2017/0082052 A1
(43) Pub. Date: Mar. 23, 2017

(54) METHOD AND DEVICE FOR ESTABLISHING WHETHER AN ERROR CONDITION EXISTS IN A MOTOR VEHICLE OR NOT

(71) Applicant: Robert Bosch GmbH, Stuttgart (DE)

(72) Inventors: Andreas Grimm, Tiefenbronn-Muehlhausen (DE); Bernd Mueller, Leonberg (DE); Evgeniya Ballmann, Stuttgart (DE); Simon Hufnagel, Herrieden (DE); Thomas Hartgen, Ludwigsburg (DE); Thomas Mauer, Schwieberdingen (DE)

(21) Appl. No.: 15/269,663

(22) Filed: Sep. 19, 2016

(30) Foreign Application Priority Data
Sep. 22, 2015 (DE) 102015218199.5

(51) Int. Cl. F02D 41/22; F02D 41/00; F02D 41/26

(52) U.S. Cl. CPC F02D 41/22; F02D 41/26; F02D 41/0097; F02D 2200/101; F02D 2200/602

(57) ABSTRACT

A method for ascertaining whether an error exists during the operation of an internal combustion engine of a motor vehicle, in which an engine control unit controls the internal combustion engine and a second control unit, in particular a higher-order vehicle control unit, of the motor vehicle is provided, in which a setpoint variable, which describes a curve of a setpoint value of an operating variable, is ascertained and, as a function of whether a comparison between a limiting value and a difference of an ascertained actual variable, which describes a curve of an actual value of the operating variable, and the ascertained setpoint variable, has the result that the difference is greater than the limiting value, it being decided whether the error exists, wherein the engine control unit receives the result of the comparison from the second control unit.

### CROSS REFERENCE

The present application claims the benefit under 35 U.S.C. §119 of German Patent Application No. DE 102015218199.5 filed on Sep. 22, 2015, which is expressly incorporated herein by reference in its entirety.

### FIELD

The present invention relates to a method for establishing whether an error condition exists in a motor vehicle or not. The present invention furthermore relates to a device, in particular a control unit, which is configured to carry out this method, and a computer program which carries out the method, and a machine-readable storage medium on which the computer program is stored.

### BACKGROUND INFORMATION

A method for controlling the drive power of a vehicle is described in German Patent No. DE 44 38 714 A1, a microcomputer being provided for carrying out control functions and monitoring functions. Microcomputers are established on at least two levels independent of one another, a first level carrying out the control function and a second level carrying out the monitoring function.

### SUMMARY

In a first aspect of the present invention, a method is provided, using which it is ascertained whether, during operation of an internal combustion engine of a motor vehicle, an error exists, in particular an unintentional acceleration. The motor vehicle includes in this case an engine control unit, which controls the internal combustion engine, and a second control unit, in particular a higher-order vehicle control unit.

The word “higher-order” may be understood as follows in this case: The higher-order vehicle control unit transmits setpoint values of operating characteristic variables of the internal combustion engine to the engine control unit. The engine control unit receives these setpoint values and controls the internal combustion engine accordingly, to bring the actual values of these operating characteristic variables into correspondence with the setpoint values. Conversely, it may be provided in particular that the engine control unit does not transmit setpoint values to the higher-order vehicle control unit, in response to which the vehicle control unit attempts, by controlling actuators, to bring the corresponding actual value into correspondence with the setpoint value.

Furthermore, according to the first aspect of the invention, in this method a curve of a setpoint value of a setpoint variable, which describes an operating variable, is ascertained. A difference for an absolute value of the difference is then ascertained from an ascertained actual variable, which describes the curve of an actual value of the operating variable, and the ascertained setpoint variable. As a function of the result of a comparison between a limiting value and this difference, it is decided whether the error exists. The operating variable may be in particular a torque, a power, or an acceleration here.

According to the first aspect of the present invention, the engine control unit receives the result of the comparison from the second control unit. Carrying out the comparison is thus delegated to the second control unit. The remaining steps of this monitoring mechanism may be implemented on the engine control unit.

This method has the advantage that parts of the monitoring mechanism may be implemented on the higher-order second control unit independently of the specific engine control unit used. The scope of the monitoring mechanism is thus reduced to the engine control unit and the development effort is reduced.

In particular, it may be provided in one variant that the setpoint variable is equal to the setpoint value of the operating variable and the actual variable is equal to the actual value of the operating variable. In an alternative variant, it may be provided that the setpoint variable is a change of the setpoint value of the operating variable and the actual variable is a change of the actual value of the operating variable.

When it has been decided that the error exists, corresponding countermeasures may be initiated to transfer the motor vehicle into a safe state. For example, a maximum torque which may be generated by the internal combustion engine may be limited.

This method may be used in a second level of the control of the internal combustion engine, in which the first level carries out the control functions and the second level carries out the monitoring function. It has the advantage that the number of the interfaces between the levels is reduced and the coupling between the levels is thus minimized, which increases the reliability.

In a second aspect of the present invention, it may be provided that the actual value of the operating variable is ascertained as the quotient of the ascertained change of the rotational energy divided by an ascertained change of a crankshaft angle, in particular in the same time interval. Such a method has proven to be particularly efficient in relation to alternative methods.

In one refinement of this aspect, it may be provided that the actual value of the operating variable is an actual value of the operating variable ascertained by the second control unit and the ascertained change of the rotational energy is ascertained as a function of an angular velocity of the crankshaft, which is received from a speed sensor. This means the angular velocity is an angular velocity ascertained by the speed sensor. This also means that the speed sensor is an intelligent sensor, which analyzes all required pieces of information. It may transmit the information via a digital or analog interface directly to the engine control unit or to the second control unit. The described method has the advantage that the development effort is particularly low for such a system topology.

It may be provided in this case that the engine control unit and/or the second control unit contain(s) a watchdog. It may furthermore be provided that the error reaction is implemented on the engine control unit, i.e., the shutdown path for the torque-relevant output stages is implemented on the engine control unit, which means that the engine control unit is capable of shutting down the output stages if it has been detected that an error exists.

According to another aspect of the present invention, it may be provided that the setpoint variable is a change of the setpoint value of the operating variable and the actual variable is a change of the actual variable of the operating variable,

the setpoint variable being ascertained as a function of a value received from an accelerator pedal sensor, i.e., a driver input, the setpoint variable being a variable ascertained by the second control unit. In particular, the setpoint variable may be ascertained as a change of the setpoint value of the operating variable as a function of a change of the driver input.

For example, the deviation may be ascertained as the difference between the setpoint variable and the actual variable. If an absolute value of the deviation is greater than a predefinable threshold value, it is thus decided thereupon that the error exists. Alternatively or additionally, it may be decided thereupon that the error exists if the difference is negative, i.e., if the change of the setpoint value is less than the change of the actual value.

In another aspect, it may be provided that the setpoint variable is ascertained with the aid of a relationship, which describes the change of the setpoint value of the operating variable as a function of the ascertained change of the driver input. This relationship may be stored, for example, in the second control unit, for example, as a characteristic map and/or as a mathematical function. Such a method is applicable particularly easily, because those influencing variables which only have a slowly changing influence on the setpoint value of the operating variable do not have to be taken into consideration in this relationship. This is possible because these influences would “be minimized” during the ascertainment of the change of the setpoint value of the operating variable.

In another aspect, it may be provided that the change of the setpoint value of the operating variable is ascertained as a difference of two setpoint values of the operating variable ascertained at successive points in time. The setpoint value of the operating variable may be ascertained in each case as a function of an ascertained value of the driver input. In this case, the consideration of influencing variables, which only have a slowly changing influence on the setpoint value of the operating variable, may also be omitted in the ascertainment of the setpoint values.

In particular, the setpoint value of the operating variable may be ascertained independently of an operating state of an air-conditioning compressor and/or a generator.

In another aspect, it may be provided that the change of the setpoint value and the change of the actual value are ascertained over a first predefinable period of time. This means the change of the setpoint value and the change of the actual value describe the change between the beginning and the end of the first predefinable period of time. It may be provided in particular in this case that when it has been decided as a function of the deviation that the error exists, a second change of the setpoint value and a second change of the actual value are ascertained over a second predefinable period of time, which is longer than a first predefinable period of time, a second deviation being ascertained as a function of the second change of the setpoint value and the second change of the actual value and it being decided as a function of the second deviation whether the error exists. Simple error debouncing may be achieved in this way.

In another aspect, it may be provided that partial deviations between the change of the setpoint value and the change of the actual value are each ascertained during successive time intervals and the deviation is ascertained as a function of the partial deviations. For example, the deviation is ascertained as a total of the partial deviations. For example, successive time intervals follow one another immediately, i.e., the end point of the preceding time interval and the starting point of a falling time interval are each coincident.

In another aspect, it may be provided that the deviation is ascertained during a third time interval, a second deviation being ascertained as a function of a change of the setpoint value and a change of an ascertained actual value of the operating variable during a fourth time interval, and it being decided whether the error exists as a function of a comparison of a first deviation to the second deviation.

In one refinement of this aspect, it may be provided that the fourth period of time includes a first working cycle of the internal combustion engine and the fifth period of time includes a second working cycle of the internal combustion engine, starting and end points in time of the fourth and the fifth periods of time being in an angle-synchronous pattern of a crankshaft of the motor vehicle. This means the deviation between the change of the setpoint value and the change of the actual value may be compared over multiple angle-synchronous time intervals, for example, over various working cycles or over various periods of time, which correspond to multiple working cycles. Such a method is particularly simple to adapt to the respective motor vehicle.

In another aspect, it may be provided that if an electrical consumer of a vehicle electrical system is turned on or off, the method is deactivated. This means that setpoint values and/or actual values which are ascertained during a period of time in which a turn-on point in time or turn-off point in time of the electrical consumer lies are not used for the comparison. The method becomes particularly reliable in this way. For example, an alternative monitoring method may be used during these periods of time.

In another aspect, it may be provided that a delay element, in particular a PT1 filter, is used in the ascertainment of the setpoint value. In particular, the ascertainment of the setpoint value and/or the ascertainment of the change of the setpoint value may be filtered by a delay element. In this way, it may be taken into consideration in a particularly simple way that a time delay may occur between an actuation of an accelerator pedal and a corresponding change of the actual value.

In further aspects, the present invention relates to a computer program which is designed to execute all steps of one of the methods according to one of the above-mentioned aspects, a machine-readable storage medium on which the computer program is stored, and a control unit, which is designed to execute all steps of one of the methods according to one of the above-mentioned aspects.

The figures show particularly advantageous specific embodiments of the present invention by way of example.

### BRIEF DESCRIPTION OF THE DRAWINGS

FIG. 1 shows a drivetrain in which the present invention may be used.

FIG. 2 shows a flow chart of a possible sequence of the method.

FIG. 3 shows a motor vehicle in which the present invention may be used.

FIG. 4 shows a structure diagram of signal flows according to one specific embodiment of the present invention.

FIG. 5 shows a structure diagram of signal flows according to another specific embodiment of the present invention.

FIGS. 6A and 6B show an illustration of a core concept of one aspect of the present invention.

FIG. 7 shows a time curve of a generator torque.

FIG. 8 shows time curves of various torques.

FIGS. 9A and 9B show flowcharts of possible specific embodiments for ascertaining the change of the setpoint value of the operating variable.

FIG. 10 shows a flow chart of the sequence of the method for ascertaining the error.

FIG. 11 illustrates the allocation of steps of the described monitoring method between engine control unit 98 and higher-order vehicle control unit 97.

FIG. 12 illustrates the allocation of steps of the described monitoring method between engine control unit 98 and higher-order vehicle control unit 97.

FIG. 13 illustrates the allocation of steps of the described monitoring method between engine control unit 98 and higher-order vehicle control unit 97.

### DETAILED DESCRIPTION OF EXAMPLE EMBODIMENTS

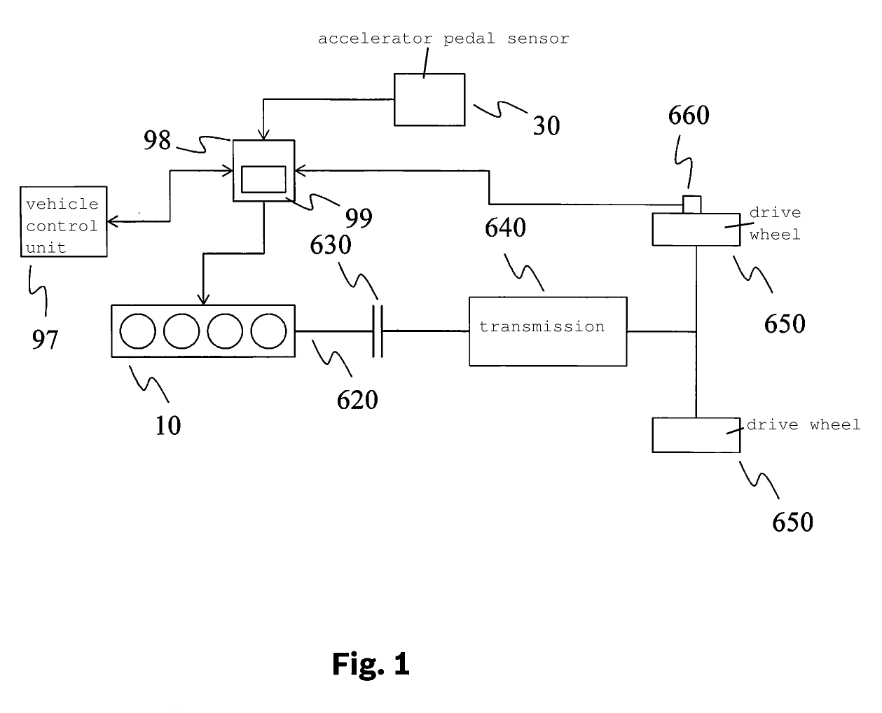

FIG. 1 shows a drivetrain of a motor vehicle. The drivetrain includes an internal combustion engine 10, which drives a crankshaft 620. Crankshaft 620 transmits the rotary motion of internal combustion engine 610 to drive wheels 650 in a routine way via a clutch 630 and a transmission 640.

Internal combustion engine 10 is controlled by an engine control unit 98. The control functions are implemented in this exemplary embodiment as software and are stored on a machine-readable storage medium 99 of engine control unit 98.

A rotation angle sensor 660 ascertains in this exemplary embodiment a rotation angle of wheel 650 and transmits it to engine control unit 98. An accelerator pedal 670 detects a driver input of a driver and transmits it to engine control unit 98, which ascertains therefrom, in a conventional way, a setpoint operating variable, for example, a setpoint torque, proceeding from which the control of internal combustion engine 10 is ascertained. Engine control unit 98 has to ensure, inter alia, that internal combustion engine 10 does not unintentionally output an excessively high torque or an excessively high power. A higher-order vehicle control unit 97 has a communication link to engine control unit 98. It receives, for example, pieces of information about an actual torque of internal combustion engine 10 and the setpoint torque from engine control unit 98 and compares the difference between these two variables to a limiting value. The result of this comparison is transmitted to engine control unit 98. Engine control unit 98 receives the result of this comparison and initiates countermeasures as a function of the result of this comparison.

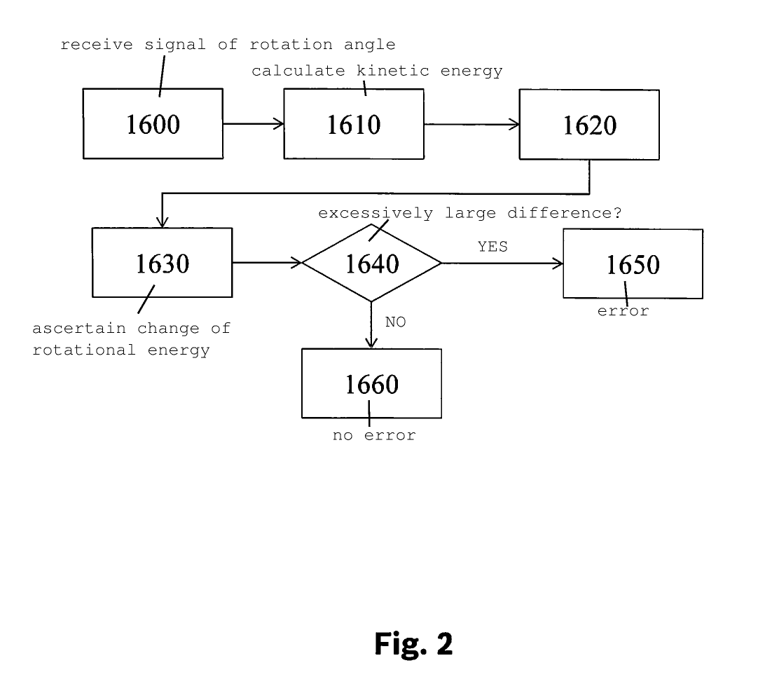

FIG. 2 shows a flow chart, which describes a possible sequence of the method. In step 1600, the signal of rotation angle φ, which is received from rotation angle sensor 660, is differentiated and speed \dot{φ} is thus ascertained. Speed \dot{φ} is ascertained in this case at two points in time: a first point in time t1 before an ignition top dead center ZOT and a second, later point in time t2 in the same working cycle, but after ZOT.

In following step 1610, the kinetic energy of internal combustion engine 610 and crankshaft 620 is calculated at both points in time as E =1/2J \dot{φ}². J is the moment of inertia of the rotating mass in this case.

In following step 1620, the change of the rotational energy is ascertained as ΔE=E(t2)−E(t1). The signal of rotation angle φ, which is received from rotation angle sensor 660, is also provided at points in time t1 and t2.

In following step 1630, actual torque Mi, which is transmitted from crankshaft 620 to the input side of clutch 630, is ascertained as

$$Mi = \frac{Δ E}{( ϕ ( t 2 ) - ϕ ( t 1 ) )} .$$

This is the actual torque which was generated by internal combustion engine 610. Setpoint torque Ms is also ascertained, which is to be generated by the internal combustion engine.

Step 1640 follows, in which difference Mi−Ms of actual torque and setpoint torque is ascertained. If this difference is excessively large, it is decided that an error exists, and the sequence branches to step 1650. Otherwise, it is decided that no error exists and the method ends in step 1660.

In step 1650, a safety function is activated in a conventional way to limit the torque output by internal combustion engine 610 and internal combustion engine 610 is shut down if necessary. A warning message is optionally output to the driver. The method thus ends.

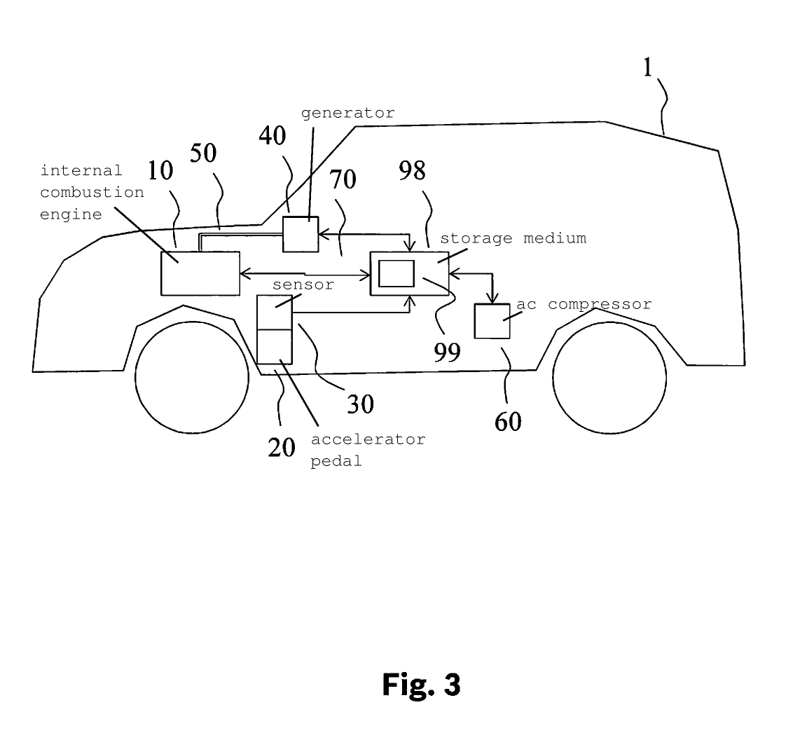

FIG. 3 shows motor vehicle 1, in which the method may be used. Motor vehicle 1 is driven by internal combustion engine 10. Internal combustion engine 10 is coupled via an operative connection, for example, a belt drive 50, to a generator 40. Engine control unit 98 is connected via a communication link 70, for example, a CAN bus, to internal combustion engine 10 and generator 40. Engine control unit 98 may control internal combustion engine 10 and generator 40 and receive signals therefrom. Engine control unit 98 may be equipped, for example, with a machine-readable storage medium 99, on which computer programs, which may run in engine control unit 98, are stored. Engine control unit 98 may also control an air-conditioning compressor 60 and receive signals therefrom. An accelerator pedal 20 may be provided in a routine way to be actuated by a driver of motor vehicle 1. Accelerator pedal sensor 30 is configured to detect a position of accelerator pedal 20 (i.e., its degree of actuation) and transmit it to engine control unit 98.

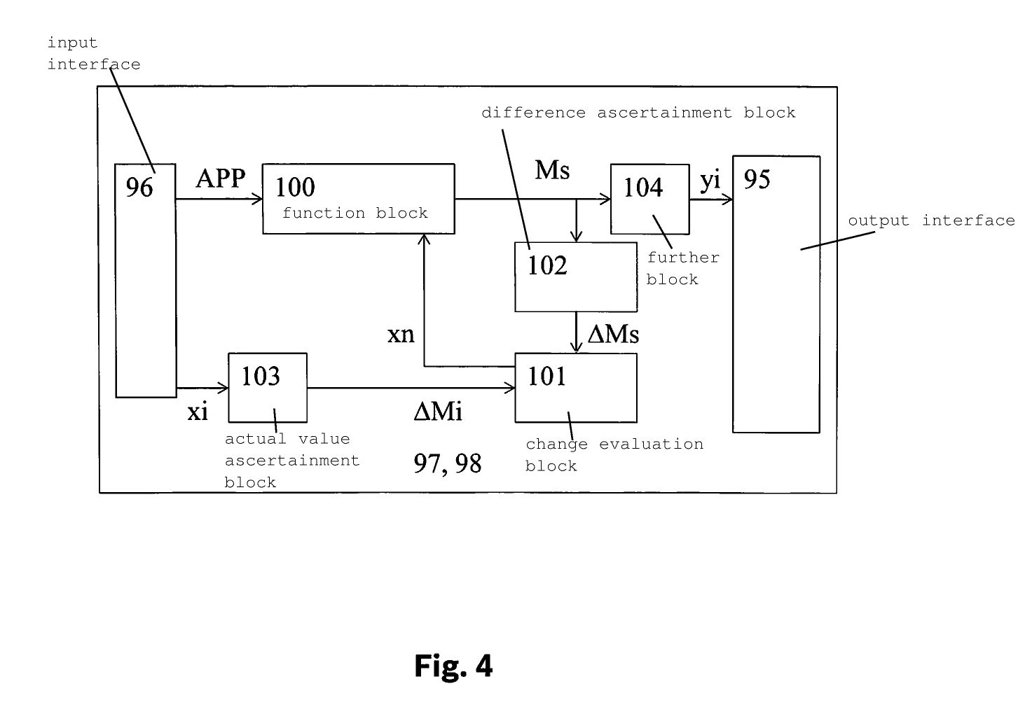

FIG. 4 shows a structure diagram of signal flows, as may take place, for example, in the composite of higher-order vehicle control unit 97 and engine control unit 98. Via an input interface 96, engine control unit 98 receives variables which characterize the present operating state of internal combustion engine 10, generator 40, accelerator pedal 20, and air-conditioning compressor 60. Driver input APP is extracted in a routine way from the signal transmitted by accelerator pedal sensor 20 and transmitted to a function block 100. Function block 100 ascertains (for example, with the aid of a characteristic map) a setpoint torque Ms, which is to be generated by internal combustion engine 10, from driver input APP and optionally further variables. This signal is transmitted to a difference ascertainment block 102 and an output interface 95. Output interface 95 transmits setpoint torque Ms to a further block 104 in engine control unit 98, which ascertains control variables yi therefrom for internal combustion engine 10, for example, an opening degree of a throttle valve, an injection quantity, an injection time, and/or an injection angle. These variables are then transmitted to internal combustion engine 10.

Difference ascertainment block 102 ascertains, from setpoint torque Ms, a change of setpoint torque ΔMs, which characterizes the change of setpoint torque Ms in relation to an earlier point in time. Input interface 96 receives, for example, from internal combustion engine 10, generator 40, air-conditioning compressor 60, and accelerator pedal sensor 30, state variables xi, which identify the particular state of these components. State variables xi are transmitted to an actual value ascertainment block 103. Actual value ascertainment block 103 ascertains an actual torque instantaneously generated by internal combustion engine 10 from state variables xi. Actual value ascertainment block 103 furthermore ascertains an actual torque change ΔMi, which characterizes a change of the ascertained actual torque in relation to an earlier point in time. Actual torque change ΔMi is transmitted to a change evaluation block 101. Change evaluation block 101 ascertains, from setpoint torque change ΔMs and actual torque change ΔMi, whether a malfunction exists during the operation of internal combustion engine 10. If this is the case, an emergency signal xn is transmitted to a function ascertainment block 100, which may initiate countermeasures to transfer internal combustion engine 10 into a safe operation.

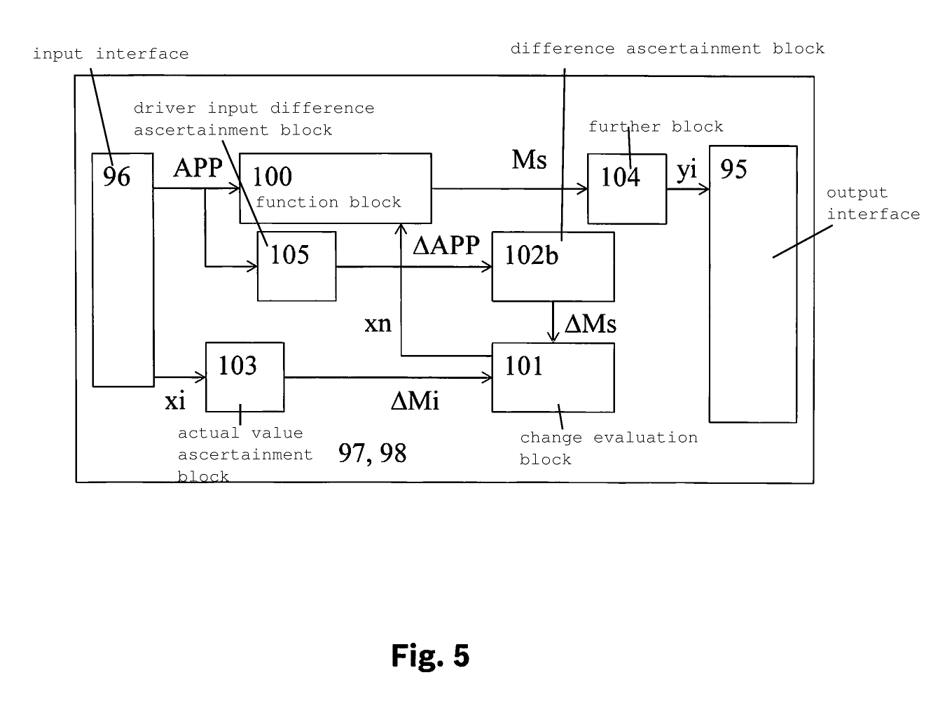

FIG. 5 shows a structure diagram of signal flows according to another specific embodiment. The way in which setpoint torque change ΔMs is ascertained here is different from the specific embodiment shown in FIG. 4. Only the parts which are changed from FIG. 4 will be described. Driver input APP is transmitted from the input interface not only to function block 100, but rather also to a driver input difference ascertainment block 105. Driver input difference ascertainment block 105 ascertains a change ΔAPP of driver input APP from an earlier point in time, and transmits it to difference ascertainment block 102b.

Difference ascertainment block 102b ascertains the change of setpoint torque ΔMs from the difference of driver input ΔAPP. The change of setpoint torque ΔMs thus ascertained is transmitted by difference ascertainment block 102b to change evaluation block 101.

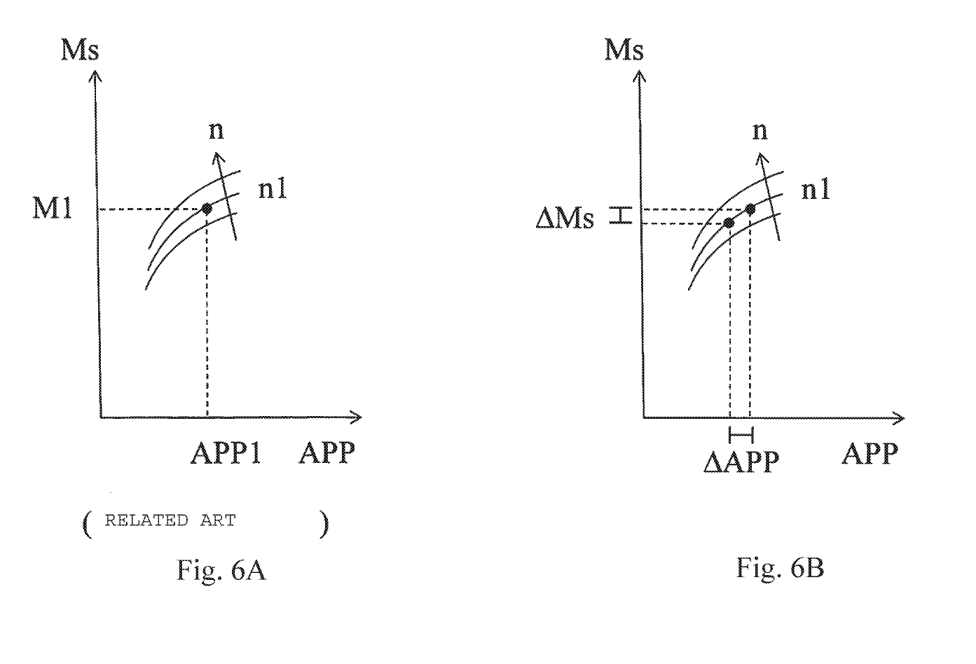

FIGS. 6A and 6B illustrate a core concept of one aspect of the present invention. FIG. 6A illustrates the basic principle of torque monitoring, as is known from the related art, for example, DE 44 38 714 A1. FIG. 6B illustrates a concept on which the present invention is based. In both FIG. 6A and FIG. 6B, torque M of internal combustion engine 10 is plotted against driver input APP. This schematic illustration is valid for both the actual torque and the setpoint torque. For a given speed n of the internal combustion engine, the curve of torque M as a function of driver input APP follows a characteristic curve. In the present illustration, a first speed n1 of internal combustion engine 10 is assumed. In the monitoring method according to the related art, associated torque M1 is ascertained from existing first driver input APP1. It is ascertained whether an error exists in the control of internal combustion engine 10 on the basis of the setpoint torque thus ascertained, in the case of the ascertained actual torque.

In contrast, it is provided according to a first aspect of the present invention that an actual value of driver input APP is not used for ascertaining the setpoint torque, but rather a change ΔAPP of the driver input. From change ΔAPP of the driver input, a change ΔMs of the setpoint torque is then ascertained, and, on the basis of the change of setpoint torque ΔMs thus ascertained with a change of the actual torque, it is inferred whether an error exists in the control of internal combustion engine 10.

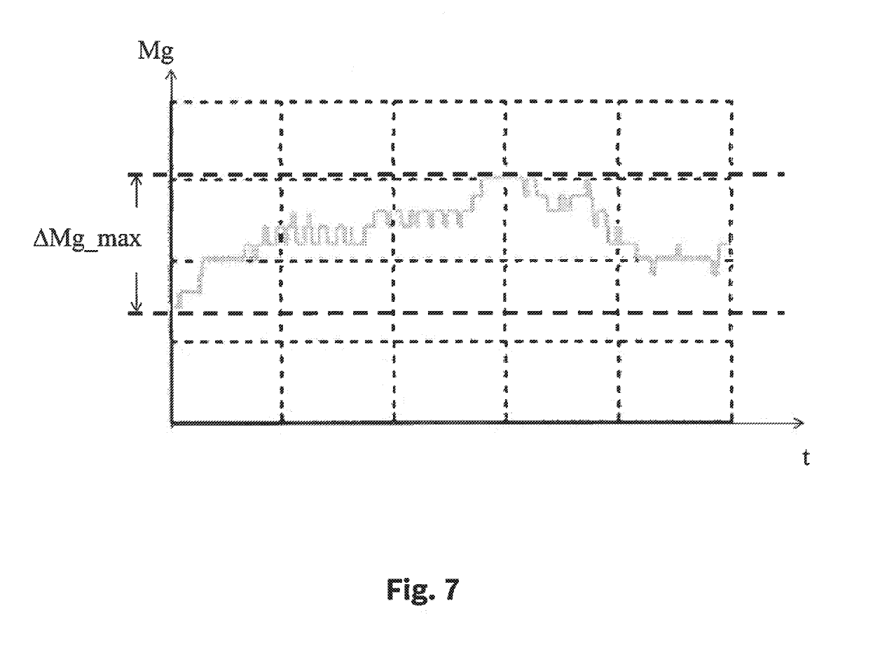

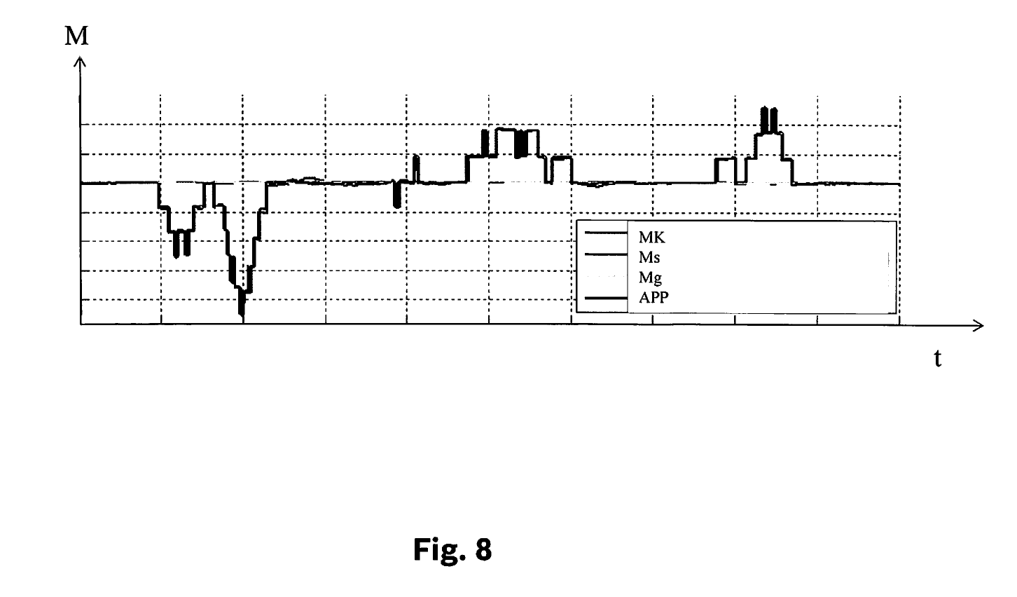

FIG. 7 and FIG. 8 illustrate the advantages of this first aspect of the present invention. FIG. 7 shows a time curve of generator torque Mg, which is generated by generator 40. The period of time shown in FIG. 7 is, for example, several seconds, for example, 25 seconds. A generator torque variation limit ΔMg_Max during this time span only assumes a small absolute value, for example, <1 Nm. As illustrated in FIG. 8, generator torque Mg therefore changes much more slowly than the torque generated by internal combustion engine 10, and may therefore be considered to be nearly constant with respect to time.

FIG. 8 shows the time curves of various torques M of components of motor vehicle 1. An air-conditioning compressor torque MK of air-conditioning compressor 60, generator torque Mg, setpoint torque Ms of internal combustion engine 10, and driver input APP. It is apparent that the torque requirements of generator 40 and air-conditioning compressor 60 remain nearly constant over time and do not have to be taken into consideration in the monitoring. It is also apparent from FIG. 8 that the changes of driver input APP correspond in a very good approximation directly to the changes of setpoint torque Ms. The friction losses of internal combustion engine 10 are also sufficiently small in this case that they may be disregarded. This means that, in the case illustrated in FIG. 8, all friction losses and all torque requirements of the secondary assemblies are so small that the changes thereof may be disregarded. In this case, the maximum decoupling is achieved between the monitoring level and the functional level. If torque losses or torque requirements of secondary assemblies do not have the property that the changes thereof are so small that they may be disregarded, the permissible changes thereof thus have to be taken into consideration in the monitoring function. The extensive decoupling between the monitoring level and the functional level is not thus dispensed with, however.

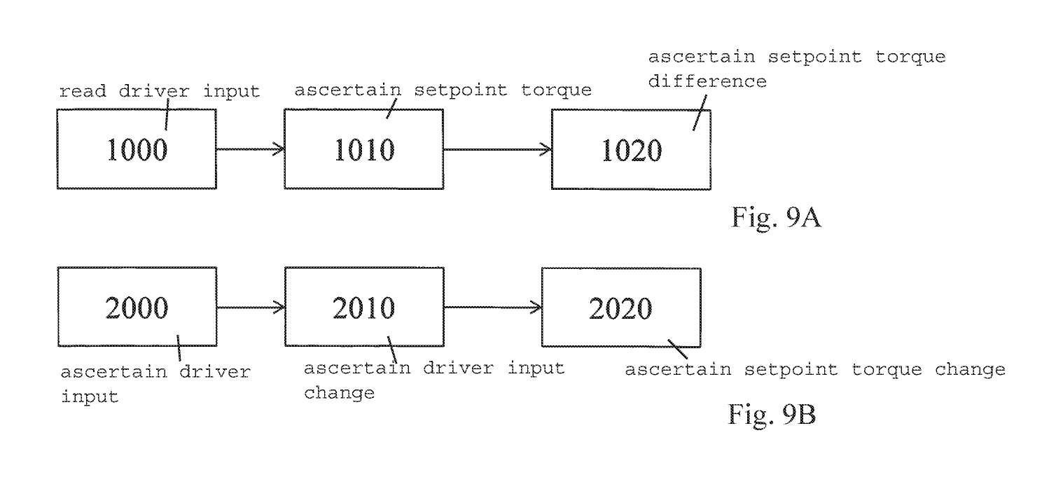

FIGS. 9A and 9B show two flow charts of methods as may be used to ascertain the difference of setpoint torque ΔMs. FIG. 9A illustrates a method as may be used in the specific embodiment illustrated in FIG. 4. In step 1000, driver input APP is read in, and in next step 1010, setpoint torque Ms, which is associated with this driver input APP, is ascertained, for example, with the aid of a characteristic map. Steps 1000 and 1010 may be carried out in function block 100. In next step 1020, which is carried out, for example, in difference ascertainment block 102, setpoint torque difference ΔMs is ascertained. A subscript i identifies discrete points in time, at each of which setpoint torque Ms is ascertained. This is identified by notation Ms_i. Setpoint torque changes ΔMs may be ascertained, for example, by the formula ΔMs_i=Ms_i−Ms_(i−1).

FIG. 9B shows a method as may be used, for example, in the specific embodiment illustrated in FIG. 5. In step 2000, driver input APP is ascertained, and in step 2010, driver input change ΔAPP is ascertained therefrom. This is carried out, for example, with the aid of the formula ΔAPP_i=APP_i−APP_(i−1). Steps 2000 and 2010 are carried out, for example, in driver input difference ascertainment block 105. In step 2020, setpoint torque change ΔMs is ascertained from driver input change ΔAPP, for example, with the aid of a characteristic map. This ascertainment may be carried out in difference ascertainment block 102b. The method for ascertaining setpoint torque change ΔMs ends with step 1020 or step 2020, respectively.

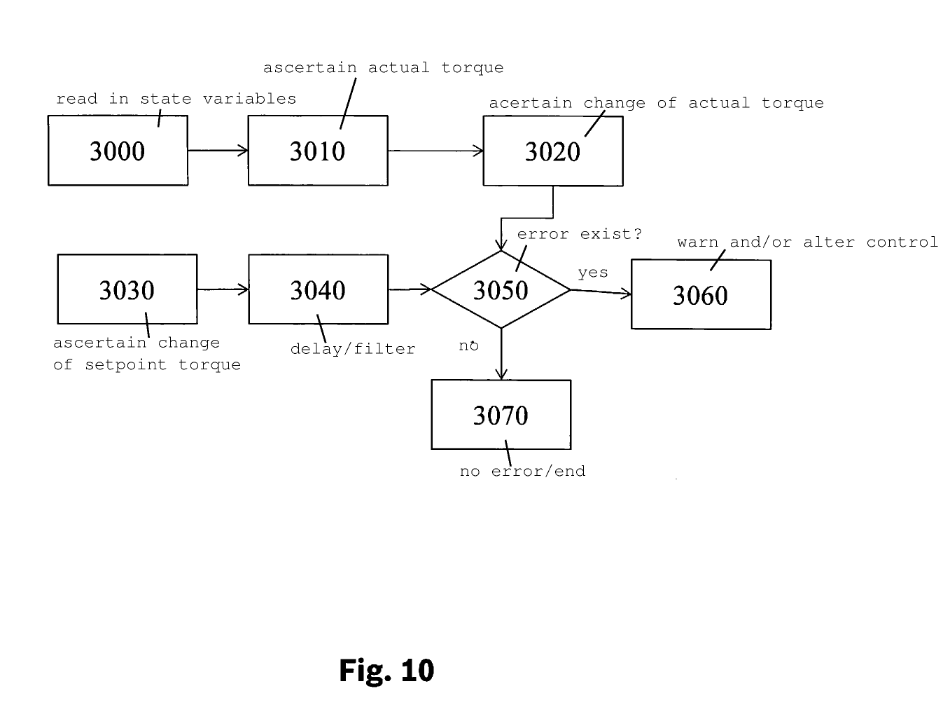

FIG. 10 shows a method for ascertaining whether an error exists in the control of internal combustion engine 10 or not. In step 3000, state variables XI are read in, and in step 3010, actual torque Mi_i for particular discrete point in time i is ascertained from state variables XI. In next step 3020, the change of actual torque ΔMi at discrete point in time i is ascertained, for example, according to the formula ΔMi_i−ΔMi_(i−1). In parallel, in step 3030, the change of setpoint torque ΔMs_i at discrete point in time i is ascertained, and optionally delayed in following step 3040, for example, with the aid of a PT1 filter. This filtering in step 3040 may accommodate the fact that actual torque Mi responds with a time delay tau in the event of the actuation of the accelerator pedal 20. In step 3050, it is ascertained whether an error exists. Multiple alternative methods are possible for this purpose.

According to a first method, it may be checked whether the difference of setpoint torque ΔMs_i corresponds to the difference of actual torque ΔMi_i. This means it may be checked whether difference ΔMs_i−ΔMi_i is less than a permissible threshold. The threshold may be selected as a function of how large the time interval of points in time i and i−1 is, on the basis of which the change of setpoint torque ΔMs_i and of actual torque ΔMi_i was ascertained. It is possible here, for example, to ascertain the differences in a 10 ms or 50 ms pattern, however, they may also be ascertained in a longer interval, for example, of 2000 ms. It may also be provided that these differences are formed step-by-step in different time intervals, for example, initially over a time interval of 20 ms, then 50 ms, then 100 ms, then 200 ms, etc. If the torque change within a first time interval, for example, 20 ms, is greater than the permissible threshold, the torque change is also checked within the next period of time, for example, 50 ms, etc. If this difference exceeds the permissible threshold in the case of a critical time interval, for example, 2000 ms, it is thus ensured in this method that this difference also exceeds the permissible threshold in all preceding time intervals. In this case, it is decided that an error exists.

In another exemplary embodiment, the changes of setpoint torques Ms_i and actual torques Mi_i may each be summed over a predefined period of time, to thus decide as a function of difference ΣₙMSᵢ−ΣₙMiᵢ whether an error exists. If this difference is greater than a threshold value, it is decided that an error exists.

In another exemplary embodiment it may be provided to form the deviation between the change of setpoint torque ΔMs_i and the change of actual torque ΔMi_i at each discrete point in time i, to sum these changes, and to then decide there are errors if this sum Σₙ(ΔMsᵢ−ΔMiᵢ) is greater than a threshold value.

In another specific embodiment, it may be provided that a particular mean change of setpoint torque ΔMs and actual torque ΔMi is ascertained, that a mean deviation between these variables is ascertained using the formula

$$\frac{1}{n} {\sum }_{i = 1}^{n} Δ {Ms}_{i} - \frac{1}{n} {\sum }_{i = 1}^{n} Δ {Mi}_{i} ,$$

and it is decided there are errors if this difference is greater than a threshold value.

In all of these specific embodiments, it is possible that the permissible threshold values are selected differently in the positive and negative directions. In particular, it is possible that a deviation in the positive direction may assume very large values (i.e., actual torque Mi may be less than setpoint torque Ms), and/or the permissible threshold value in the negative direction is selected to be significantly smaller than the permissible threshold value in the positive direction, i.e., it is rapidly decided that there are errors if actual torque Mi is greater than setpoint torque Ms. This is because an inadvertent acceleration exists in the case of a negative deviation, which may result in a hazardous situation.

The particular considered time intervals may be calculated in the segment of synchronous patterns, i.e., synchronously to revolutions of a crankshaft of internal combustion engine 10. This means the time intervals are of different lengths and are a function of the speed of internal combustion engine 10. If an error is detected, step 3060 follows, in which a warning message may be output to the driver of motor vehicle 1 and/or the control of internal combustion engine 10 may be altered in such a way that internal combustion engine 10 is operated in safeguarded operation. If it has been detected in step 3050 that no error exists, the method ends in step 3070.

The described specific embodiments are not restricted to the operating variable “torque.” Instead of a torque of the internal combustion engine, a power of the internal combustion engine, or an acceleration of motor vehicle 1, may be used equivalently. If the monitoring is carried out on the basis of the operating variable “acceleration,” the external influences which cause a slow increase of the acceleration may be eliminated. These may be, for example, disturbances which arise due to the air resistance and/or the rolling friction. The disturbances which are caused by the slope of the roadway may also be eliminated by the formation of the differences in a sufficiently short time interval, for example, 10 ms.

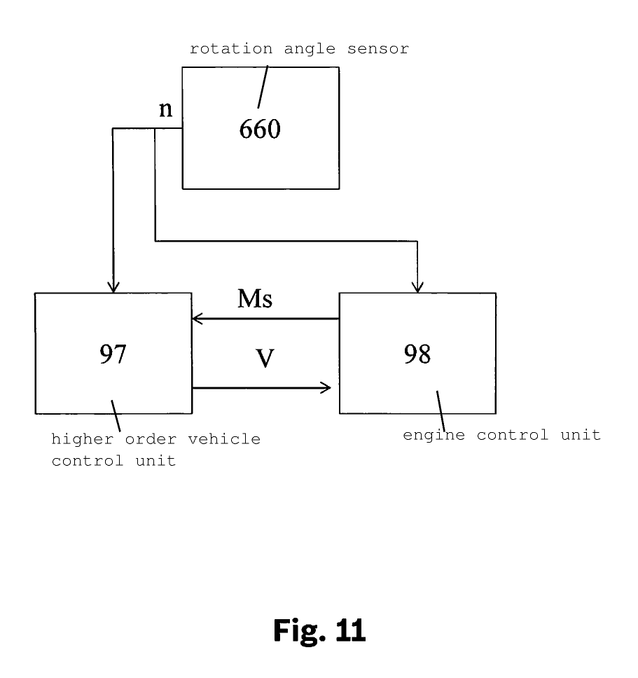

FIGS. 11 through 13 illustrate the allocation of steps of the described monitoring method between engine control unit 98 and higher-order vehicle control unit 97.

FIG. 11 illustrates a specific embodiment in which rotation angle sensor 660 is designed as an intelligent speed sensor, which ascertains speed n, i.e., angular velocity n of crankshaft 620, as a function of the tooth times ascertained by same. This angular velocity n is transmitted to engine control unit 98 and higher-order vehicle control unit 97 and received by same.

Engine control unit 98 receives further sensor variables which are required for ascertaining setpoint torque Ms, checks them for contradictions, and ascertains setpoint torque Ms provided that the check for contradictions has not shown that contradictions exist. Engine control unit 98 transmits setpoint torque Ms to vehicle control unit 97.

Vehicle control unit 97 checks whether received speed n is contradictory to further pieces of information which are provided to vehicle control unit 97. If this is not the case, vehicle control unit 97 ascertains actual torque Mi. Vehicle control unit 97 then ascertains difference Mi−Ms and checks whether it is greater than a predefinable limiting value. The result of this comparison is transmitted as logical bit V to engine control unit 98 and it is decided therein as a function of the value of logical bit V whether an error exists or not, and countermeasures are initiated if necessary, for example, output stages are shut down.

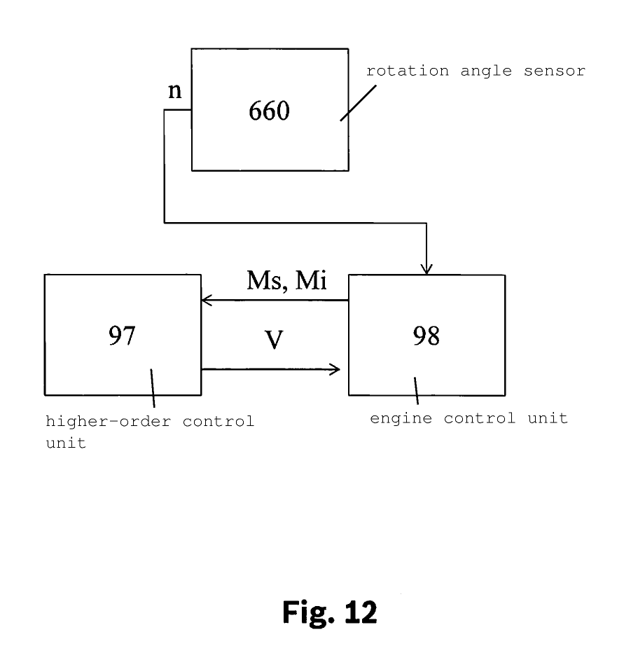

FIG. 12 illustrates another specific embodiment. In contrast to the specific embodiment illustrated in FIG. 11, rotation angle sensor 660 transmits its signal only to engine control unit 98, but not to vehicle control unit 97. Rotation angle sensors 660 transmit the rotation angle signal of crankshaft 620 to engine control unit 98, which ascertains angular velocity n of crankshaft 620 therefrom. Engine control unit 98 receives further sensor variables which are required for the ascertainment of setpoint torque Ms, checks them for contradictions, and ascertains setpoint torque Ms provided that the check for contradictions has not shown that contradictions exist. Engine control unit 98 transmits setpoint torque Ms to vehicle control unit 97.

Engine control unit 98 furthermore checks whether received speed n is contradictory to further pieces of information which are provided to engine control unit 98. If this is not the case, engine control unit 98 ascertains actual torque Mi and transmits it to vehicle control unit 97. Vehicle control unit 97 then ascertains difference Mi−Ms and checks whether it is greater than a predefinable limiting value. The result of this comparison is transmitted as a logical bit V to engine control unit 98 and it is decided therein as a function of the value of logical bit V whether an error exists or not, and countermeasures are initiated if necessary, for example, output stages are shut down.

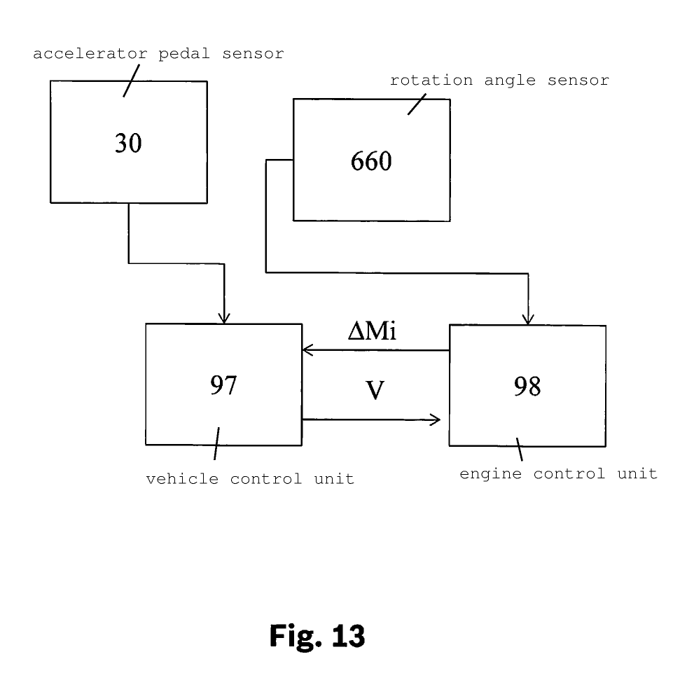

FIG. 13 illustrates another specific embodiment, which is meaningful in particular for the method illustrated in FIGS. 3 through 10. Rotation angle sensor 660 transmits the rotation angle signal of crankshaft 620 to engine control unit 98, which ascertains angular velocity n of crankshaft 620 therefrom. This angular velocity n is transmitted to engine control unit 98 and higher-order vehicle control unit 97 and received by same.

Vehicle control unit 97 receives a signal from accelerator pedal sensor 30, which characterizes the position of accelerator pedal 20, and checks it for contradictions and ascertains the change of setpoint torque ΔMs, provided that the check for contradictions has not shown that contradictions exist.

Engine control unit 98 checks whether received speed n is contradictory to further pieces of information which are provided to engine control unit 98. If this is not the case, engine control unit 98 ascertains the change of actual torque ΔMi. Engine control unit 98 transmits the change of actual torque ΔMi to vehicle control unit 97.

Vehicle control unit 97 then ascertains difference ΔMi−ΔMs and checks whether it is greater than a predefinable limiting value. The result of this comparison is transmitted as a logical bit V to engine control unit 98 and it is decided therein as a function of the value of logical bit V whether an error exists or not, and countermeasures are initiated if necessary, for example, output stages are shut down.

It is apparent to those skilled in the art that the described method may be implemented in software or in hardware or in a mixed form of hardware and software.

What is claimed is:

1. A method for ascertaining whether an error exists during the operation of an internal combustion engine of a motor vehicle, in which an engine control unit controls the internal combustion engine and a second control unit of the motor vehicle is provided, the second control unit being a higher-order vehicle control unit, the method comprising:
ascertaining a setpoint variable which describes a curve of a setpoint value of an operating variable, is ascertained; and
as a function of whether a comparison between a limiting value and a difference of an ascertained actual variable, which describes a curve of an actual value of the operating variable, and the ascertained setpoint variable, has a result that the difference is greater than the limiting value, deciding whether the error exists; and
receiving, by the engine control unit, the result of the comparison from the second control unit.

2. The method as recited in claim 1, wherein the actual value of the operating variable is ascertained as a quotient of the ascertained change of a rotational energy divided by an ascertained change of a crankshaft angle.

3. The method as recited in claim 2, wherein the actual value of the operating variable is an actual value of the operating variable ascertained by the second control unit and the ascertained change of the rotational energy is ascertained as a function of an angular velocity of the crankshaft received from a speed sensor.

4. The method as recited in claim 1, wherein the setpoint variable is a change of the setpoint value of the operating variable and the actual variable is a change of the actual value of the operating variable, the setpoint variable being ascertained as a function of a value received from an accelerator pedal sensor, the setpoint variable being a variable ascertained by the second control unit.

5. The method as recited in claim 1, wherein, if it has been ascertained that an error exists, the internal combustion engine is controlled in such a way that the actual value of the operating variable is limited to values less than a maximum value.

6. A non-transitory machine-readable storage medium on which is stored a computer program for ascertaining whether an error exists during the operation of an internal combustion engine of a motor vehicle, in which an engine control unit controls the internal combustion engine and a second control unit of the motor vehicle is provided, the second control unit being a higher-order vehicle control unit, the computer program, when executed by a computer, causing the computer to perform:
ascertaining a setpoint variable which describes a curve of a setpoint value of an operating variable, is ascertained; and
as a function of whether a comparison between a limiting value and a difference of an ascertained actual variable, which describes a curve of an actual value of the operating variable, and the ascertained setpoint variable, has a result that the difference is greater than the limiting value, deciding whether the error exists; and
causing receiving, by the engine control unit, the result of the comparison from the second control unit.

7. A control unit for ascertaining whether an error exists during the operation of an internal combustion engine of a motor vehicle, in which an engine control unit controls the internal combustion engine and a second control unit of the motor vehicle is provided, the second control unit being a higher-order vehicle control unit, the control unit designed to:
ascertain a setpoint variable which describes a curve of a setpoint value of an operating variable, is ascertained; and
as a function of whether a comparison between a limiting value and a difference of an ascertained actual variable, which describes a curve of an actual value of the operating variable, and the ascertained setpoint variable, has a result that the difference is greater than the limiting value, decide whether the error exists; and
receive, by the engine control unit, the result of the comparison from the second control unit.
